(19) United States
(12) Patent Application Publication
(10) Pub. No.: US 2009/0182703 A1
(43) Pub. Date: Jul. 16, 2009

(54) EXPOSING RELATIONAL DATABASE INTERFACES ON XML DATA

(75) Inventors: Arunpriyaa Nachimuthu, Kirkland, WA (US); Anil K. Prasad, Kondapur (IN); Mustansir K. Doctor, Madhapur (IN); Jayanthi Sampathkumar, Mylapore (IN); Tapas K. Nayak, Gachibowli (IN)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/015,382

(22) Filed: Jan. 16, 2008

(51) Int. Cl. G06F 17/30

(52) U.S. Cl. 707/1; 707/E17.125

(57) ABSTRACT

Mapping XML elements to complex relational database structures. One method includes acts for storing mark-up language representations of data in a complex relational database structure. The method includes receiving an XSD document. The XSD document defines at least one type that should be mapped to a complex relational database type. The XSD document is mapped to a relational database structure. An XML document is received. The XML document is interpreted according to the XSD document. One or more elements of the XML document are mapped to complex relational database elements based on mapping of the XSD document to the relational database structure.

### BACKGROUND

### BACKGROUND AND RELEVANT ART

Computers and computing systems have affected nearly every aspect of modern living. Computers are generally involved in work, recreation, healthcare, transportation, entertainment, household management, etc.

An LOB (line-of-business) application is a computer application used to run some portion or aspect of an enterprise. For example, an LOB application may be an inventory management application, a customer database application, an accounting application, an e-commerce application, etc.

Typically, an LOB application communicates using a proprietary communication language and protocol. In contrast, clients wishing to communicate with LOB applications could communicate with just XML (eXtensible Markup Language) messages. To bridge LOB applications and clients, adapters may be implemented to translate the XML messages to the proprietary LOB application messages.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes a method that may be practiced in a computing environment. The method includes acts for storing mark-up language representations of data as a complex relational database structure. The method includes receiving an XSD (XML Schema Definition) document. The XSD document defines at least one type that should be mapped to a complex relational database type. The XSD document is mapped to a relational database structure. An XML document is received. The XML document is interpreted according to the XSD document. One or more elements of the XML document are mapped to complex relational database elements based on mapping of the XSD document to the relational database structure.

Yet another embodiment is directed to a method of storing mark-up language representations of data in a complex relational database structure. The method may be practiced in a computing environment. The method includes receiving an XML document. The method further includes determining that the XML document includes elements that should be mapped to a complex relational database structure. The elements are mapped to a complex relational database structure.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates communication between an LOB application, an adapter, an XML data reader, and a client;

FIG. 2 illustrates a schematic representation of mapping hierarchical XML data to relational database elements;

FIG. 3 illustrates a method of mapping XML data to relational database elements; and

FIG. 4 illustrates a method of mapping XML elements to complex database elements.

### DETAILED DESCRIPTION

Some embodiments described herein are directed to facilitating communication between relational database systems and systems that communicate primarily using hierarchical based mark-up language messages. For example, some embodiments may be directed to interfacing adapters which communicate using XML messages with clients that include relational databases or relational database applications. Additionally, some embodiments include functionality for allowing data expressed as complex XML elements or attributes to be stored as complex relational database elements. Complex relational database elements may include nested tables, columns or rows. Further, other simple XML elements may also be stored as complex relational database elements when appropriate, as explained in more detail below.

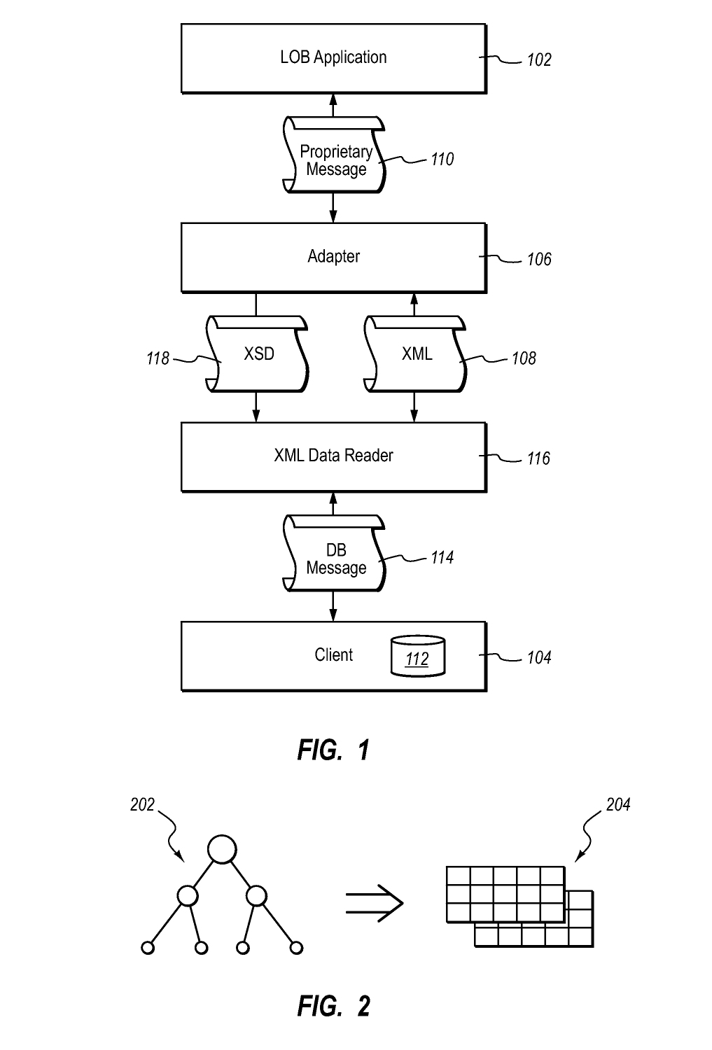

Referring now to FIG. 1, an example is illustrated. FIG. 1 illustrates communication between an LOB application 102 and a relational database based client 104. FIG. 1 further illustrates an adapter 106. The adapter 106 includes functionality for converting XML messages 108 to and from messages 110 in a proprietary language and/or protocol used for communicating with the LOB application 102.

This facilitates an ability for clients which communicate using XML based messages to communicate with LOB applications 102 through adapters such as the adapter 106. However, as previously described, some clients such as client 104 include relational databases 112 and are configured to communicate using a relational database language including relational database messages such as relational database message 114 illustrated in FIG. 1. To facilitate communication of clients 104 with the LOB application 102, one embodiment implements an XML data reader 116. The XML data reader 116 is able to read XML messages 108 from the adapter 106 and convert the XML messages 108 to relational database elements communicated in a relational database message 114. Illustratively, FIG. 2 illustrates a hierarchical data structure 202 that may be mapped to a relational database structure 204.

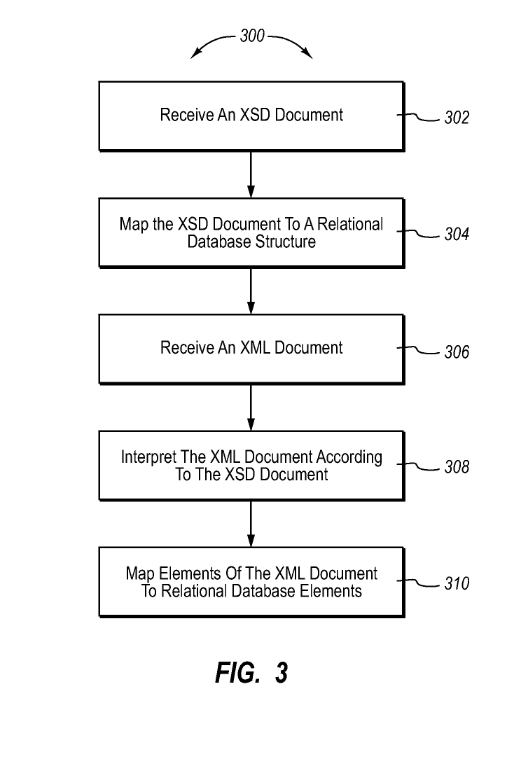

An example of this functionality is illustrated now with reference to FIG. 3 which shows a method of storing mark-up language data in relational databases. The following description of FIG. 3 also makes reference to FIG. 1 to illustrate various examples. FIG. 3 illustrates an act of receiving an XSD (XML Schema Definition) document (act 302). An XSD document is a definition document that defines how elements in an XML document should be interpreted. For example, an XSD document may be a schema including rules and structure definitions defining how XML documents should be structured. FIG. 1 illustrates that an XSD document 118 is provided by the adapter 106 and received by the XML data reader 116. This allows the XML data reader 116 to be able to interpret XML documents received at the XML data reader 116.

FIG. 3 further illustrates an act of mapping an XSD document to a relational database structure (act 304). For example, embodiments may map structural elements of the XSD document 118 to structural elements of the relational database 112. For example, the following illustrates a basic example of portions of XSD document code:

<xs:element name=“firstname” type=“xs:string”/>

This code may map to a table containing a single column named “firstname” in a relational database. Other examples, that will be discussed in more detail may be more complex and may include functionality for mapping XML types to complex database elements.

FIG. 3 further illustrates an act of receiving an XML document (act 306). As illustrated in FIG. 1, The XML data reader 116 may receive the XML document 108. The XML document contains instantiated elements defined for the elements of the XSD document. For example, for the sample XSD code illustrated above, corresponding XML code may be:

<firstname>Priyaa</firstname>

FIG. 3 further illustrates that the method 300 further includes an act of interpreting the XML document according to the XSD document (act 308). FIG. 3 further illustrates that the method 300 further includes an act of mapping elements of the XML document to relational database elements (act 310). Thus, for example, as illustrated in FIG. 1, elements in the XML document 108 may be mapped to be entered into the relational database 112.

Illustrating now the embodiment described previously, corresponding XML code is as follow:

<firstname>Priyaa</firstname>

This XML code may be mapped such that the following table appears in the relational database:

| Table name | rowid | firstname |
|---|---|---|
| firstname | 1 | Priyaa |

The method 300 may further be performed such that mapping elements of the XML document to relational database elements includes mapping names of elements and attributes to tables and columns.

The method 300 may further be performed such that mapping elements of the XML document to relational database elements includes mapping XSD types to CLR (Common Language Runtime) types.

As will be illustrated in a number of the examples below, the method 300 may further be performed such that mapping elements of the XML document to relational database elements includes mapping XML elements that include complex elements to complex relational database columns.

The method 300 may further be performed such that mapping elements of the XML document to relational database elements includes mapping XML elements that do not include complex elements to primitive relational database columns.

The method 300 may further be performed such that mapping elements of the XML document to relational database elements includes determining that an attribute includes a constraint indicating that the attribute is restricted. Based on determining that an attribute includes a constraint indicating that the attribute is restricted, the method 300 further includes excluding the attribute from mapping elements of the XML document to relational database elements.

The method 300 may further be performed such that mapping elements of the XML document to relational database elements includes mapping a default value of an element or attribute specified by the XSD document to a relational database element. In one embodiment, the method 300 may further include validating a user input value by comparing the user input value to the default value. An exception may be thrown if the user input value does not match the default value.

The method 300 may further be performed such that mapping elements of the XML document to relational database elements includes mapping XML sequences that occur more than once to complex relational database columns.

The following now illustrates mapping of a number of different XML types and attributes to relational database elements.

### Simple XML Types

The following examples illustrate example mappings for simple XML types to appropriate relational database mappings. For example, the following illustrates an example where an element occurs a maximum of one time. The following illustrates example XSD code for this instance:

<xs:element name=“firstname” type=“xs:string”/>

An example of corresponding instantiated XML code is as follows:

<firstname>Priyaa</firstname>

The resulting relational database entry is a primitive type column as illustrated below:

| Table name | rowid | firstname |
|---|---|---|
| firstname | 1 | Priyaa |

In another example, an element may occur a maximum of more than one time. The following illustrates example XSD code for this case:

```
<xs:element name=“person” type=“personinfo” />
  <xs:complexType name=“personinfo”>
    <xs:sequence>
    <xs:element name=“firstname” type=“xs:string” maxOccurs=“10”/>
      <xs:element name=“lastname” type=“xs:string”/>
      </xs:sequence>
    </xs:complexType>
```

An example of corresponding instantiated XML code is as follows:

<person>
<firstname>John</firstname>
<firstname>Beth</firstname>
<firstname>Cathy</firstname>
<firstname>Abby</firstname>
<lastname>Myers</lastname>
</person>

While this example is for a simple XML type, because of the multiple element instances, the resulting relational database entry is a complex type column as illustrated below:

| | | firstname | | | |
|---|---|---|---|---|---|
| | | (Table name) | | | |
| Table name | rowid | rowid | firstname | parentid | lastname |
| person | 1 | 2 | John | 1 | Myers |
| | | 3 | Beth | 1 | |
| | | 4 | Cathy | 1 | |
| | | 5 | Abby | 1 | |

### Attributes

The following illustrate mappings to relational databases from attributes of XML documents. Attributes can generally be mapped to simple or primitive relational database elements.

The following illustrates example XSD code for attributes:

```
<xs:element name=“Age”>
  <xs:complexType>
  <xs:simpleContent>
    <xs:extension base=“xs:integer”>
    <xs:attribute name=“country” type=“xs:string” />
    </xs:extension>
  </xs:simpleContent>
  </xs:complexType>
</xs:element>
```

An example of corresponding instantiated XML code is as follows:

<Age country=“neverland”>30</Age>

This XML code may be mapped to a primitive type column as illustrated in the following example:

| Table name | rowid | country | Age |
|---|---|---|---|
| Age | 1 | neverland | 30 |

### Complex XML Types

The following illustrate complex XML types. One complex XML type is a type which includes empty elements. The following illustrates example XSD code for such a type:

<xs:element name=“firstname” type=“xs:string”/>

An example of corresponding instantiated XML code is as follows:

<firstname/>

This XML code may be mapped to a primitive type column as illustrated in the following example:

| Table name | rowid | firstname |
|---|---|---|
| firstname | 1 | |

Another complex XML type may include empty elements with attribute(s). The following illustrates example XSD code for such a type:

```
<xs:element name=“Age”>
  <xs:complexType>
    <xs:attribute name=“country” type=“xs:string” />
  </xs:complexType>
</xs:element>
```

An example of corresponding instantiated XML code is as follows:

<Age country=“neverland”/>

This XML code may be mapped to a primitive type column as illustrated in the following example:

| Table name | rowid | country |
|---|---|---|
| Age | 1 | neverland |

Another complex XML type includes empty elements that contain only text or other simple content. The following illustrates example XSD code for such an example:

```
<xs:element name=“Age”>
  <xs:complexType>
  <xs:simpleContent>
    <xs:extension base=“xs:integer”>
    </xs:extension>
  </xs:simpleContent>
  </xs:complexType>
</xs:element>
```

An example of corresponding instantiated XML code is as follows:

<Age>30</Age>

The resulting relational database table includes a primitive type column. An example is illustrated below:

| Table name | rowid | Age |
|---|---|---|
| Age | 1 | 30 |

Another complex XML type includes elements with only child elements with which occur a maximum of one time. The following illustrates example XSD code for an example embodiment:

```
<xs:element name=“person” type=“personinfo”>
</xs:element>
  <xs:complexType name=“personinfo”>
  <xs:sequence>
  <xs:element name=“bloodgroup” type=“string”/>
  <xs:element name=“firstname” type=“xs:string”/>
  <xs:element name=“lastname” type=“xs:string”/>
  </xs:sequence>
  <xs:attribute name=“Age” type=“xs:int”/>
</xs:complexType>
```

An example of corresponding instantiated XML code is as follows:

<person Age=”35”>
<bloodgroup>B</bloodgroup>
<firstname>John</firstname>
<lastname>Nash</lastname>
</person>

The resultant relational database table is a table with primitive type columns as illustrated below:

| Table name | rowid | bloodgroup | firstname | lastname | Age |
|---|---|---|---|---|---|
| person | 1 | B | John | Nash | 35 |

Another complex XML type includes elements with only child elements that occur a maximum number of times more than one. The following illustrates example XSD code for this embodiment:

```
<xs:element name=“person” type=“personinfo”>
</xs:element>
  <xs:complexType name=“personinfo”>
  <xs:sequence>
  <xs:element name=“bloodgroup” maxOccurs = “15” type=“string”/>
  <xs:element name=“firstname” type=“xs:string”/>
  <xs:element name=“lastname” type=“xs:string”/>
  </xs:sequence>
  </xs:complexType>
```

An example of corresponding instantiated XML code is as follows:

<person Age=”35”>
<bloodgroup>B</bloodgroup>
<bloodgroup>A+</bloodgroup>
<bloodgroup>O</bloodgroup>
<firstname>John</firstname>
<lastname>Nash</lastname>
</person>

The preceding XML code maps to a complex table as illustrated below:

| | | bloodgroup | | | | |
|---|---|---|---|---|---|---|
| Table | | (Table name) | | | | |
| name | rowid | rowid | bloodgroup | parentid | firstname | lastname |
| person | 1 | 2 | B | 1 | John | Nash |
| | | 3 | A+ | 1 | | |
| | | 4 | O | 1 | | |

Another example of a complex XML type includes an XML element with a complex element and occurs a maximum of one time. The following illustrates example XSD code for this example:

```
<complexType name=“intPair”>
    <sequence>
    <element name=“int1” type=“int” />
    <element name=“int2” type=“int” />
    </sequence>
  </complexType>
  <complexType name=“namedIntPair”>
    <sequence>
    <element name=“name” type=“string” />
    <element name=“vector” type=“test:intPair” />
    </sequence>
  </complexType>
  <element name=“SampleResponse”>
    <complexType>
    <sequence>
    <element name=“namedVector” type=“test:namedIntPair” />
    <element name=“origin” type=“string” />
    </sequence>
  </complexType>
  </element>
```

An example of corresponding instantiated XML code is as follows:

```
<SampleResponse >
  <namedVector>
  <name>James</name>
  <vector>
    <int1>4</int1>
    <int2>5</int2>
  </vector>
  </namedVector>
<origin> Maths</origin>
</SampleResponse>
```

This XML code maps to a complex table with a complex column, such as is illustrated below:

| | | namedVector | | | | | | | |
|---|---|---|---|---|---|---|---|---|---|
| | | (Table name) | | | | | | | |
| Table | | | | vector (Table name) | | | | | |
| name | rowid | rowid | name | rowid | int1 | int2 | parentid | parentid | origin |
| person | 1 | 2 | James | 3 | 4 | 5 | 2 | 1 | Maths |

Another example of a complex XML type includes an XML element with a complex element that has a maximum occurrence of more than one. The following illustrates example XSD code for this example:

```
<complexType name=“intPair”>
  <sequence>
    <element name=“int1” type=“int” />
    <element name=“int2” type=“int” />
  </sequence>
  </complexType>
  <complexType name=“namedIntPair”>
  <sequence>
    <element name=“name” type=“string” />
    <element name=“vector” type=“test:intPair” />
  </sequence>
  </complexType>
  <element name=“SampleResponse”>
  <complexType>
    <sequence>
    <element name=“namedVector” maxOccurs=”10”
    type=“test:namedIntPair” />
    <element name=“origin” type=“string” />
    </sequence>
  </complexType>
  </element>
```

An example of corresponding instantiated XML code is as follows:

```
<SampleResponse >
  <namedVector>
  <name>James</name>
  <vector>
    <int1>4</int1>
    <int2>5</int2>
  </vector>
  </namedVector>
  <namedVector>
  <name>Nathan </name>
  <vector>
    <int1>99</int1>
    <int2>88</int2>
  </vector>
  </namedVector>
<origin> Maths</origin>
</SampleResponse>
```

This XML code maps to a complex table with complex columns with multiple rows as shown in the following example:

| | | namedVector | | | | | | | |
|---|---|---|---|---|---|---|---|---|---|
| | | (Table name) | | | | | | | |
| Table | | | | vector (Table name) | | | | | |
| name | rowid | rowid | name | rowid | int1 | int2 | parentid | parentid | origin |
| person | 1 | 2 | James | 3 | 4 | 5 | 2 | 1 | Maths |
| | | 4 | Nathan | 5 | 99 | 88 | 4 | 1 | |

Another example of a complex XML type includes an XML element with complex and simple elements mixed. The following illustrates example XSD code for this example:

```
<complexType name=“intPair”>
    <sequence>
    <element name=“int1” type=“int” />
    <element name=“int2” type=“int” />
    </sequence>
  </complexType>
  <complexType name=“namedIntPair”>
    <sequence>
    <element name=“name” type=“string” />
    <element name=“vector” type=“test:intPair” />
    </sequence>
  </complexType>
  <element name=“SampleResponse”>
    <complexType>
    <sequence>
      <element name=“namedVector” type=“test:namedIntPair” />
      <element name=“origin” type=“string” />
    </sequence>
    </complexType>
  </element>
```

An example of corresponding instantiated XML code is as follows:

```
<SampleResponse >
  <namedVector>
  <name>James</name>
  <vector>
    <int1>4</int1>
    <int2>5</int2>
  </vector>
  </namedVector>
<origin> Maths</origin>
</SampleResponse>
```

The following illustrates mapping of the above XML to a complex table with complex type and simple type columns:

| | | namedVector | | | | | | | |
|---|---|---|---|---|---|---|---|---|---|
| | | (Table name) | | | | | | | |
| Table | | | | vector (Table name) | | | | | |
| name | rowid | rowid | name | rowid | int1 | int2 | parentid | parentid | origin |
| person | 1 | 2 | James | 3 | 4 | 5 | 2 | 1 | Maths |

Another example of a complex XML type includes an element with complex and simple element and occurs a maximum number of times greater than one. The following illustrates example XSD code for this example:

```
<complexType name=“intPair”>
    <sequence>
    <element name=“int1” type=“int” />
    <element name=“int2” type=“int” />
    </sequence>
  </complexType>
  <complexType name=“namedIntPair”>
    <sequence>
    <element name=“name” type=“string” />
    <element name=“vector” type=“test:intPair” />
    </sequence>
  </complexType>
  <element name=“SampleResponse”>
    <complexType>
    <sequence>
    <element name=“namedVector” type=“test:namedIntPair” />
    <element name=“origin” maxOccurs=”5” type=“string” />
    </sequence>
  </complexType>
  </element>
```

An example of corresponding instantiated XML code is as follows:

```
<SampleResponse >
  <namedVector>
  <name>James</name>
  <vector>
    <int1>4</int1>
    <int2>5</int2>
  </vector>
  </namedVector>
<origin> Maths</origin>
<origin> Physics</origin>
</SampleResponse>
```

Mapping this XML code to a relational database results in a complex table with complex type columns, such as the example table illustrated below:

| | | namedVector | | | | | | | | | |
|---|---|---|---|---|---|---|---|---|---|---|---|
| | | (Table name) | | | | | | | origin | | |
| Table | | | | vector (Table name) | | | | | (Table name) | | |
| name | rowid | rowid | name | rowid | int1 | int2 | parentid | parentid | rowid | origin | parentid |
| person | 1 | 2 | James | 3 | 4 | 5 | 2 | 1 | 3 | Maths | 1 |
| | | | | | | | | | 4 | Physics | 1 |

Embodiments may be configured such that the XML data reader 116 understands occurrence constraints for the purpose of creating the correct relational shape so that the associated XML data can be correctly shredded into it. The XML data reader 116 may use occurrence information to determine if element is single valued or multi-valued. This means all MaxOccurs>1 or MinOccurs>1 are treated as many valued and are promoted to MaxOccurs=unbounded and treated as a many valued elements.

In some embodiments, elements that have MinOccurs=0 and MaxOccurs=0 will be ignored. This is done, in some embodiments, because a sever object management data model may strip out such elements during compilation such that these elements are not available to the XML data reader 116.

In some embodiments, if attributes are constrained by an identifier that identifies them as prohibited use, they are excluded from the mapping.

An element or attribute with a simple type list may be mapped to CLR type List<T> where T is the CLR type associated with the item type of the list. For dataset mapping, list types may be mapped to columns of type string.

An element or attribute with a union simple type may be mapped to the untyped CLR type object. Simple types defined using union can have contents from any of the simple types that are part of the union. It may not possible to map union simple type definitions to a single strongly typed CLR types. Thus, in one embodiment a union simple type definition is mapped to a system object type. For dataset mapping, union types are mapped to string as object types may not be mapped to attributes in dataset.

The Xml data reader 116 will support default or fixed facets associated with elements or attributes in the input XSD schema. Row instances will receive the default/fixed value for the respective columns if either the associated element/attribute is missing.

In cases where a fixed value is provided in the XSD schema for a given element/ attribute and the user provides an explicit value for the same element/ attribute values via the source document, the Xml data reader 116 will validate that the instance value matches the fixed value via a lexical comparison. If the values do not match, in one embodiment, an exception will be thrown.

A given XSD schema instance can be thought of as closed when it does not make use of any element or any attribute. If any constructs are used then the XSD schema can be thought of as being open. An XML instance associated with such schema can replace the any element and any attribute with other appropriate attributes and elements. In one embodiment, the Xml data reader 116 will treat content associated with any element and any attribute as extra content and will ignore it.

The following table illustrates illustrative mapping that may be performed:

| | Xml Data Reader | Dataset |
|---|---|---|
| XmlTypeCode | CLR Type | CLR Type |
| XmlTypeCode.None | Object | Object |
| XmlTypeCode.AnyAtomicType | Object | Object |
| XmlTypeCode.Boolean | Boolean | Boolean |
| XmlTypeCode.String | String | String |
| XmlTypeCode.Decimal | Decimal | Decimal |
| XmlTypeCode.Element | XmlDataReader | XmlDataReader |
| XmlTypeCode.Float | Single | Single |
| XmlTypeCode.Double | Double | Double |
| XmlTypeCode.Duration | TimeSpan | TimeSpan |
| XmlTypeCode.DateTime | DateTime | DateTime |
| XmlTypeCode.Time | Time | Time |
| XmlTypeCode.Date | DateTime | DateTime |
| XmlTypeCode.GYear | DateTime | DateTime |
| XmlTypeCode.GYearMonth | DateTime | DateTime |
| XmlTypeCode.GMonthDay | DateTime | DateTime |
| XmlTypeCode.GDay | DateTime | DateTime |
| XmlTypeCode.GMonth | DateTime | DateTime |
| XmlTypeCode.HexBinary | Byte[ ] | Byte[ ] |
| XmlTypeCode.Base64Binary | Byte[ ] | Byte[ ] |
| XmlTypeCode.AnyUri | System.Uri | System.Uri |
| XmlTypeCode.Notation | String | String |
| XmlTypeCode.NormalizedString | String | String |
| XmlTypeCode.Language | String | String |
| XmlTypeCode.NmToken | String | String |
| XmlTypeCode.NMTokens | String[ ] | String |
| XmlTypeCode.Name | String | String |
| XmlTypeCode.NCName | String | String |
| XmlTypeCode.Id | String | String |
| XmlTypeCode.Idref | String | String |
| XmlTypeCode.Idrefs | String[ ] | String |
| XmlTypeCode.Token | String | String |
| XmlTypeCode.QName | XmlQualifiedName | String |
| XmlTypeCode.Entity | String | String |
| XmlTypeCode.Entities | String[ ] | String |
| XmlTypeCode.Integer | Int32 | Int32 |
| XmlTypeCode.- | Int32 | Int32 |
| NonPositiveInteger | | |
| XmlTypeCode.NegativeInteger | Int32 | Int32 |
| XmlTypeCode.Long | Int64 | Int64 |
| XmlTypeCode.Int | Int32 | Int32 |
| XmlTypeCode.Short | Int16 | Int16 |
| XmlTypeCode.Byte | SByte | SByte |
| XmlTypeCode.- | Uint32 | Uint32 |
| NonNegativeInteger | | |
| XmlTypeCode.UnsignedLong | UInt64 | UInt64 |
| XmlTypeCode.UnsignedInt | UInt32 | UInt32 |
| XmlTypeCode.UnsignedShort | UInt16 | UInt16 |
| XmlTypeCode.UnsignedByte | Byte | Byte |
| XmlTypeCode.PositiveInteger | UInt32 | UInt32 |
| XmlTypeCode.- | TimeSpan | TimeSpan |
| YearMonthDuration | | |
| XmlTypeCode.- | TimeSpan | TimeSpan |
| DayTimeDuration | | |
| XmlTypeCode.UntypedAtomic | Object | Object |

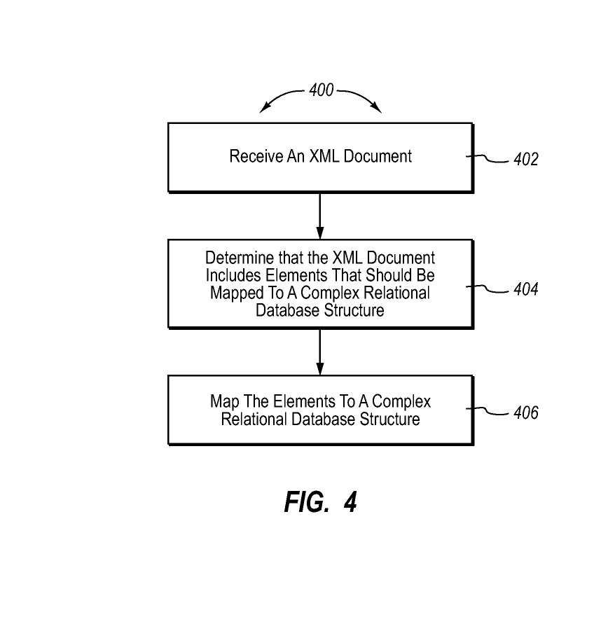

FIG. 4 further illustrates yet another embodiment that may be implemented to facilitate handling of mapping XML elements to complex table elements. FIG. 4 illustrates a method 400 which includes an act of receiving an XML document (act 402). A determination is then made that the XML document includes elements that should be mapped to a complex relational database structure (act 404). The method 400 further includes an act of mapping the XML elements to a complex relational database structure (act 406). Determining that an XML document includes elements that should be mapped to a complex relation database structure may include, for example, determining that an XML element occurs a maximum of more than one time, determining that an XML element includes child elements that occur a maximum of more than one time, or determining that an XML element is a complex XML element.

Embodiments herein may comprise a special purpose or general-purpose computer including various computer hardware, as discussed in greater detail below.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of storing mark-up language representations of data in a complex relational database structure, the method comprising:
receiving an XSD document, wherein the XSD document defines at least one type;
mapping the XSD document to a relational database structure;
receiving an XML document;
interpreting the XML document according to the XSD document; and
mapping one or more elements of the XML document to complex relational database elements based on mapping of the XSD document to the relational database structure.

2. The method of claim 1, further comprising storing elements in the XML document in a relational database based on mapping elements of the XML document to relational database elements.

3. The method of claim 1, wherein mapping elements of the XML document to relational database elements comprises mapping names of elements and attributes to tables and columns;

4. The method of claim 1, wherein mapping elements of the XML document to relational database elements comprises mapping XSD types to CLR types.

5. The method of claim 1, wherein mapping elements of the XML document to relational database elements comprises mapping XML elements that include complex elements to complex relational database columns.

6. The method of claim 1, wherein mapping elements of the XML document to relational database elements comprises mapping XML elements that do not include complex elements to primitive relational database columns.

7. The method of claim 1, wherein mapping elements of the XML document to relational database elements comprises mapping XML sequences that occur more than once to complex relational database columns.

8. The method of claim 1, wherein mapping elements of the XML document to relational database elements comprises determining that an attribute comprises a constraint indicating that the attribute is restricted, and based on determining that an attribute comprises a constraint indicating that the attribute is restricted, excluding the attribute from mapping elements of the XML document to relational database elements.

9. The method of claim 1, wherein mapping elements of the XML document to relational database elements comprises mapping a default value of an element or attribute specified by the XSD document to a relation database element.

10. The method of claim 9 further comprising, validating a user input value by comparing the user input value to the default value, and throwing an exception of the user input value does not match the default value.

11. In a computing environment, a computer readable medium comprising computer executable instructions that when executed by a processor are configured to perform the following:
receiving an XSD document, wherein the XSD document defines at least one type;
mapping the XSD document to a relational database structure;
receiving an XML document;
interpreting the XML document according to the XSD document; and
mapping one or more elements of the XML document to complex relational database elements based on mapping of the XSD document to the relational database structure.

12. The computer readable medium of claim 11, further comprising computer executable instructions that when executed by the processor are configured to store elements in the XML document in a relational database based on mapping elements of the XML document to relational database elements.

13. The computer readable medium of claim 11, wherein mapping elements of the XML document to relational database elements comprises mapping names of elements and attributes to tables and columns;

14. The computer readable medium of claim 11, wherein mapping elements of the XML document to relational database elements comprises mapping XSD types to CLR types.

15. The computer readable medium of claim 11, wherein mapping elements of the XML document to relational database elements comprises mapping XML elements that include complex elements to complex relational database columns.

16. The computer readable medium of claim 11, wherein mapping elements of the XML document to relational database elements comprises mapping XML elements that do not include complex elements to primitive relational database columns.

17. In a computing environment, a method of storing mark-up language representations of data in a complex relational database structure, the method comprising:
receiving an XML document;
determining that the XML document comprises elements that should be mapped to a complex relational database structure; and
mapping the elements to a complex relational database structure.

18. The method of claim 17, wherein determining that the XML document comprises elements that should be mapped to a complex relational database structure comprises determining that an XML element occurs a maximum of more than one time.

19. The method of claim 17, wherein determining that the XML document comprises elements that should be mapped to a complex relational database structure comprises determining that an XML element includes child elements that occur a maximum of more than one time.

20. The method of claim 17, wherein determining that the XML document comprises elements that should be mapped to a complex relational database structure comprises determining that an XML element is a complex element.
